(19) United States
(12) Patent Application Publication
(10) Pub. No.: US 2024/0234870 A1
(43) Pub. Date: Jul. 11, 2024

(54) BATTERY ARRANGEMENT AND METHOD FOR PRODUCING A BATTERY ARRANGEMENT

(71) Applicant: Ford Global Technologies, LLC, Dearborn, MI (US)

(72) Inventors: Thomas Baranowski, Würselen (DE); Raphael Koch, Odenthal (DE); Maik Broda, Würselen (DE); Marcel Mathissen, Übach-Palenberg (DE)

(21) Appl. No.: 18/405,087

(22) Filed: Jan. 5, 2024

(30) Foreign Application Priority Data
Jan. 10, 2023 (DE) 102023100401.8

(51) Int. Cl. H01M 10/6568; H01M 10/625; H01M 10/6561; H01M 50/227; H01M 50/244; H01M 50/298; H05B 3/26; H05B 3/56

(52) U.S. Cl. CPC H01M 10/6568; H01M 10/625; H01M 10/6561; H01M 50/227; H01M 50/244; H01M 50/298; H05B 3/267; H05B 3/565; H01M 2220/20; H05B 2203/011

(57) ABSTRACT

A battery arrangement for a vehicle, comprising a plastic container, having a plastic container base, an electrical line integrated in the plastic container base, a battery unit arranged in the plastic container, an electrical connector which is partially integrated in the plastic container base and provides an electrical connection between the electrical line and the battery unit, a plastic cover, and a temperature control unit which is arranged between the plastic container base and the battery unit, wherein the temperature control unit has a fluid channel through which a temperature control fluid can flow in order to control the temperature of the battery unit.

### CROSS-REFERENCE TO RELATED APPLICATIONS

This disclosure claims priority to German patent application Ser. No. 10/202,3100401.8, which was filed on 10 Jan. 2023 and is incorporated herein by reference in its entirety.

### TECHNICAL FIELD

The present disclosure relates to a battery arrangement for a vehicle and to a method for producing a battery arrangement.

### BACKGROUND

A battery arrangement can basically be understood as meaning a system consisting of a plurality of components. Thus, for example, a battery arrangement can be understood as meaning, for example, a battery unit arranged in a battery housing, such as a plastic container, the battery arrangement being formed from the components of a plastic container and a battery unit. A battery unit arranged in such a plastic container can be closable by a plastic cover, which may also be part of a battery arrangement. It is known to cool battery units, which is why corresponding cooling units may also be part of a battery arrangement. It is also known to connect a battery unit to an electrical line via electrical connectors. In addition, electrical energy for an electrical consumer can be provided by the battery unit; a battery unit can be charged, as it were, via an electrical line.

A battery unit may be formed by a single battery cell or a plurality of battery cells. A single battery cell or a plurality of battery cells may also be understood as meaning a battery unit. One or more rechargeable batteries or rechargeable battery cells may also be understood as meaning a battery unit.

In times of increasing electromobility and progressive development of electrically operated vehicles, battery units are increasingly used for providing the required drive energy or for the electrical supply for electrical consumers. Accordingly, there is a growing interest in the development of suitable battery housings, strategies for efficient temperature control and suitable production processes. Plastic containers in particular can be considered to be suitable battery housings.

Battery units are exposed to a wide range of weather conditions during their use (e.g. in vehicles), regardless of whether they are or are not arranged in a battery housing, such as a plastic container. Accordingly, there is an increasing interest in the development of technical solutions that enable efficient temperature control (cooling and/or heating) of such battery arrangements. This is because the efficiency of a battery unit may be temperature-dependent.

Reference should be made for prior art firstly to DE 697 05 174 T2, which is concerned with the closing of a thermoplastic battery housing. DE 10 2019 201 986 B4 discloses a battery housing together with a cooling unit. A battery management module is known from DE 10 2013 016 845 A1. DE 11 2018 004 454 T5 is also concerned with the thermal management of batteries. The document US 2015/0318525 A1 discloses another battery housing, as does U.S. Pat. No. 9,490,460 B2. In addition, reference should be made to documents DE 10 2012 012 663 A1 and DE 10 2018 216 833 A1 as regards the technological background.

### SUMMARY

The present disclosure is not limited to the field of wheel-bound vehicles (such as cars, lorries, buses, commercial vehicles and agricultural vehicles). A battery arrangement according to exemplary aspects of this disclosure may also be used in rail-bound vehicles, aircraft or other vehicles or equipment.

A object of exemplary embodiments of the present disclosure can be to provide a method for providing a battery arrangement that allows manufacturing in high unit quantities. The object can be achieved by a battery arrangement having the features of Claim 1.

An object of the disclosed examples can be to provide a battery arrangement with a compact and simplified structure, which can be produced effectively, quickly and in high unit quantities. This object is achieved by a battery arrangement having the features of Claim 11.

It should be noted that the features specified individually in the claims may be combined with one another in any desired technically meaningful manner (even beyond category limits, for example between the battery arrangement and method) and disclose further refinements.

It should also be noted that a conjunction “and/or” which is used herein and is situated between two features so as to link them should always be interpreted to mean that it is possible in a first refinement of the subject matter for only the first feature to be present, in a second refinement for only the second feature to be present, and in a third refinement for both the first and the second feature to be present.

As already mentioned, the disclosed embodiments relates to a battery arrangement for a vehicle. The battery arrangement can include a plastic container, having a plastic container opening, a plastic container base, and an encircling plastic container side wall adjacent to the plastic container base, wherein the plastic container opening lies opposite the plastic container base.

In this context, as mentioned above, a vehicle can be understood as meaning any type of vehicle, including wheel-bound and rail-bound vehicles. In particular, cars, lorries, buses, commercial vehicles and agricultural vehicles can be understood as being the vehicle. A battery arrangement according to examples of the present disclosure may also be used in rail-bound vehicles, aircraft or other vehicles or equipment.

The plastic container may be manufactured from any suitable plastic. The plastic may be a pure type, but plastic composites (which may also be understood as meaning fiber-reinforced plastic), plastic mixtures or the like may also form the plastic container.

The plastic container preferably has a plastic container interior, which is delimited to the outside by the plastic container base and the plastic container side wall. The above-mentioned encircling plastic container side wall may be composed of a plurality of partial side walls, which are arranged successively in the encircling direction. Side walls which are in each case adjacent in the encircling direction may be arranged at an angle to one another. Alternatively, the plastic container side wall may also be formed by a single side wall, which may be cylindrical in the encircling direction, for example (i.e. no partial side walls).

The fact that the plastic container base is adjacent to the plastic container side wall can be understood to the effect that the plastic container base is connected to the plastic container side wall (for example, in an integrally bonded manner). A form-fitting or force-fitting connection is also possible. The plastic container base (which can form a bottom of the plastic container) and the plastic container side wall (which can be formed from a plurality of partial side walls) form a one-piece or integral component.

Furthermore, the battery arrangement according to exemplary aspects of this disclosure can comprises an electrical line integrated in the plastic container base. Integration can be understood as meaning that the electrical line is directly embedded in the plastic material of the plastic container base. This means that the electrical line is at least partially surrounded by the plastic material of the plastic container base. The provision of a channel in the plastic container base and an arrangement of an electrical line therein may also be understood as meaning “integration”. It should be stressed that a plurality of electrical lines may also be integrated in the plastic container base. The electrical line may also comprise a main line and associated sub-lines (branched lines), all of which can be integrated in the plastic container base.

Furthermore, the battery arrangement according to exemplary aspects of this disclosure can comprise a battery unit arranged in the plastic container. The battery unit is preferably arranged in the above-mentioned plastic container interior. As mentioned, a battery unit may be formed by a single battery cell or a plurality of battery cells. A single battery cell or a plurality of battery cells may also be understood as meaning a battery unit. One or more rechargeable batteries or rechargeable battery cells may also be understood as meaning a battery unit. A plurality of battery units may also be arranged in the plastic container. Preferably, the battery unit is arranged fixed in terms of movement in the plastic container, which means that the battery unit cannot slip or move relative to the plastic container. For this purpose, fastening means of a known type can be used. The plastic container interior can be filled with a filling material that surrounds the battery unit. The filling material may be, for example, an acoustically and/or thermally insulating filling material. The filling material may also have fire-retardant properties. Furthermore, the filling material may also have a cooling effect.

In addition, the battery arrangement can comprise an electrical connector that is partially integrated in the plastic container base and provides an electrical connection between the electrical line and the battery unit. A plurality of electrical connectors may be provided that connect the electrical line (or a plurality of electrical lines) to the battery unit or to a plurality of battery units. “Partial” integration can be understood here as meaning that the electrical connector is directly embedded with a part (but not completely) in the plastic material of the plastic container base, and protrudes with a part from said plastic material into the plastic container interior. That part of an electrical connector which is integrated in the plastic container base may be connected to the electrical line, and that part of the electrical connector which protrudes into the plastic container interior may be connected to the battery unit. The electrical connector may for example, enable a plug connection to the battery unit and be designed as a plug connector.

Integration can mean here that the electrical connector is partially surrounded by the plastic material of the plastic container base. The provision of a channel in the plastic container base and a partial arrangement of the electrical connector therein can also be understood as meaning “integration.”

The electrical line and the electrical connector have an electrically conductive material, this electrically conductive material being able to be surrounded by electrically insulating material. An electrical insulation may also be formed by the plastic container base (at least in the regions in which the electrical line or the electrical connector is integrated in the plastic container base). The electrical line and/or the electrical connector may have an electrically conductive core which is surrounded by insulation. An “electrical line” may be branched and have a main wire, as well as branches (secondary wires). An “electrical line” may also be understood as meaning a network or grid composed of one or more main wires and branch wires. An “electrical line” may be a metal wire that may be surrounded by insulation. A network or grid may be composed of one or more metal wires.

The battery arrangement according to exemplary aspects of the present disclosure can comprises a plastic cover with which the plastic container opening can be covered. The plastic cover may be manufactured from any suitable plastic. The plastic may be a pure type, but plastic composites, plastic mixtures or the like may also form the plastic cover. For example, the plastic container and the plastic cover may be manufactured from the same material. The plastic container (or the plastic container opening) can be closed to the outside by the plastic cover. Closing on the basis of an integrally bonded connection between the plastic cover and the plastic container can be preferred in some examples. Alternatively, a form-fitting connection or a force-fitting connection is also possible.

Furthermore, examples of the battery arrangement can comprise a temperature control unit which is arranged between the plastic container base and the battery unit, wherein the temperature control unit has a fluid channel through which a temperature control fluid can flow in order to control the temperature of the battery unit. The temperature control unit can be connected heat-conductively to the plastic container base or arranged in such a way that a heat-conductive coupling between the plastic container base and the temperature control unit is realized. Further, the temperature control unit can be heat-conductively connected to the battery unit or arranged in such a way that a heat-conductive coupling between the battery unit and the temperature control unit is realized. A heat-conductive coupling can be provided by direct or indirect contact (i.e. by interconnecting other heat-conductive components) of two coupling partners (e.g. temperature control unit with plastic container base or temperature control unit with battery unit).

“Temperature control” can in particular be understood as meaning “cooling” or “heating.” Depending on the operation, the battery unit may heat up or be exposed to high outside temperatures. In these cases, it may be advantageous to cool the battery unit via a temperature control unit that acts as a cooling unit. In certain situations, it may also be advantageous to heat a battery unit, for example at low outside temperatures or before a vehicle is started (in the sense of preheating or warming up). This can be done via a temperature control unit that acts as a heating unit. The above-mentioned temperature control unit can also act bi-functionally, i.e. can cool or heat depending on requirements.

A temperature control fluid may be gaseous or liquid, with it being possible for the temperature control fluid to be used for cooling or heating (i.e. it can act as a cooling fluid or heating fluid). The temperature control fluid can flow through the fluid channel. A temperature control fluid may be pumped or conducted as a flow through the fluid channel, but it may also be filled into (contained in) the fluid channel statically (i.e. not pumped). The fluid channel may provide a fluid circuit. The fluid channel may begin and end outside the plastic container, in particular outside the plastic base; in particular, the fluid channel may have an inlet and/or outlet arranged outside the plastic container, in particular outside the plastic container base. When the fluid channel is designed as a fluid circuit, the fluid channel may also be guided as a fluid channel outside the plastic container or outside the plastic container base. The fluid channel may be guided through one or more heat exchangers or may form a part of one or more heat exchangers. One or more heat exchangers may also be interconnected in the fluid channel. The heat exchanger(s) is/are preferably arranged outside the plastic container. The heat exchanger(s) may be part of the vehicle. The temperature control fluid may be a synthetic refrigerant, for example on the basis of a hydrocarbon compound, but may also be water or air.

In one refinement, the battery arrangement may comprise a heating element which is arranged on the plastic container or on the plastic cover and, in the case of a plastic container opening covered by the plastic cover, is designed for this purpose for producing a joining connection between a plastic-container-side joining section and a plastic-cover-side joining section, or for releasing an already existing joining connection, by heating of the heating element. A plurality of plastic-container-side joining sections may be provided on the plastic container. A plurality of plastic-cover-side joining sections may also be provided on the plastic cover. Thus, a plurality of joining connections between the plastic cover and the plastic container can be produced or released. A plurality of optionally individually activatable heating elements may also be arranged in the plastic container or the plastic cover.

The production of a joining connection between the plastic-container-side joining section and the plastic-cover-side joining section under the action of heat (of the heating element) may be referred to as plastic welding. Owing to the heat provided by the heating element, the plastic present in the joining sections softens and may liquefy. The plastic material of the plastic-container-side joining section fuses with plastic material of the plastic-cover-side joining section (optionally by being pressed against each other or by application of a pressing force to the plastic container and plastic cover at least in the region of the joining sections). After a subsequent cooling process, a material bond (integral) is provided between the plastic-container-side joining section and the plastic-cover-side joining section. Plastic welding using a heating element may be referred to as heating element welding. This process may also be used to weld different plastic materials together. The process can be automated, for example using suitable machines or robotics.

According to the reverse principle, an already existing joining connection between the plastic container and the plastic cover can be released by means of a heating element. The plastic joined in the region of the joining connection(s) softens and possibly liquefies as a result of the action of heat. The plastic cover can then be removed/detached from the plastic container (e.g. under the action of a pulling force or shear force). By using a heating element already arranged on the plastic container or plastic cover for releasing an existing joining connection between the plastic container and plastic cover, the use of additional tools (e.g. blades) or complex processes for releasing the joining connection can be dispensed with. In addition, the joining connection may be automatically released in this way.

The joining connection may be formed by induction welding, especially when using plastic reinforced with electrically conductive fibers—such as carbon fibers. It is advantageous here if the plastic reinforced with electrically conductive fibers are provided in particular in the plastic-container-side joining section and the container-side joining section. Plastic not reinforced with electrically conductive fibers may also be used outside the joining sections.

The function of a heating element used in the context of this disclosure (which heating element is arranged directly on the plastic container or plastic cover) may thus be bi-functional, because it can—as mentioned—be used for producing a joining connection or for releasing such a joining connection.

The plastic container and/or the plastic cover may be manufactured by injection molding, but also by additive manufacturing or by a forming process. The plastic container and/or the plastic cover may be constructed in one piece (integrally) or in multiple pieces. In the case of a multi-part construction, the respective parts can be manufactured by injection molding, additive manufacturing or by a forming process. In the case of a multi-part design, the parts can be connected to one another by means of fastening means. Fastening means may be formed by form-fitting elements or force-fitting elements. The parts may also be fastened by means of an adhesive connection.

According to another example battery arrangement, it can be provided that the plastic container is manufactured from a thermoplastic or a fiber-reinforced thermoplastic at least in the region of the plastic-container-side joining section, and that the plastic cover is manufactured from a thermoplastic or a fiber-reinforced thermoplastic at least in the region of the plastic-cover-side joining section. On the plastic-container side and/or plastic-cover side, a plurality of joining sections may also be provided. Outside the joining sections, the plastic container and/or plastic cover may be manufactured from a thermoplastic or other plastic (e.g. a thermosetting plastic). Fiber-reinforced plastic may also be used in these regions. The joining sections provide the joining connection between the plastic container and the plastic cover, the joining connection preferably being an integrally bonded connection.

If, on the plastic-container side and plastic-cover side, a plurality of (plastic-container-side and plastic-cover-side) joining sections are in each case provided, the number of plastic-container-side joining sections preferably corresponds to the number of plastic-cover-side joining sections. The plastic-container-side joining sections and the plastic-cover-side joining sections are preferably uniformly distributed over a plastic-container-side or plastic-cover-side edge. However, the number of plastic-container-side joining sections and plastic-cover-side joining sections may also be unequal.

Thermoplastic are characterized by the fact that they can be deformed to a certain temperature during heating (e.g. by heating with a heating element) (provided that a molten state is reached at this temperature). This process is reversible, i.e. it can be repeated several times by cooling and reheating until the molten state is reached, as long as no thermal decomposition of the material occurs. Therefore, thermoplastic are also suitable for plastic welding.

For example, the thermoplastic may be PP, PA (e.g. PA6, PA66) PPS, PMMA, PC, PPA, PLA, PET, PE, PS, PEEK, PVC, ABS or any other thermoplastic material. A thermoplastic reinforced with fibers may also be used for additive manufacturing, e.g. a thermoplastic reinforced with glass fibers, carbon fibers and/or natural fibers.

According to a further refinement of a battery arrangement, it can be provided that the plastic-container-side joining section and the plastic-cover-side joining section at least partially lie against each other, with the plastic container opening covered by the plastic cover, before the joining connection is formed or after the joining connection is released. The plastic-cover-side joining section preferably lies opposite the plastic-container-side joining section. If a plurality of plastic-container-side joining sections and plastic-cover-side joining sections are provided, they preferably lie at least partially against one another before forming the joining connection or after releasing the joining connection.

According to a further refinement of a battery arrangement, it can be provided that the heating element is arranged on the plastic-container-side joining section or on the plastic-cover-side joining section. This makes it possible to heat up the thermoplastic or fiber-reinforced thermoplastic in the region of the joining sections to a temperature at which a molten (deformable) state of the plastic is reached, such that, for example, a joining connection (plastic welding connection) between the plastic container and the plastic cover can be provided by application of pressure. This can be followed by cooling/curing. In addition, in an already existing joining connection, hardened plastic can be transferred into a molten state with the heating element such that the plastic cover can be removed from the plastic container (e.g. using a tensile or shear force) and therefore the joining connection can be released. The heating element may be fastened to the plastic container or plastic cover in the region of the joining sections in any technically expedient manner, e.g. via an adhesive connection. The heating element may also be directly integrated in the plastic material of the plastic container or plastic cover. Since, with the plastic container opening covered with the plastic cover, the plastic-container-side joining section and the plastic-cover-side joining section lie at least partially against each other before the joining connection is formed, it is sufficient, in order to provide a joining connection, to arrange the heating element either on the plastic container or on the plastic cover, in order, because of the spatial vicinity, also to apply heat energy sufficiently to that joining partner (plastic cover or plastic container) on which no heating element is arranged to ensure that the thermoplastic or fiber-reinforced thermoplastic is transferred into a molten state.

In another example battery arrangement, it can be provided that the heating element is formed conductively with respect to an electric current such that the heating element can be heated when the electric current is impressed by an electrical contact means. The heating element may have one or more contact points, which are contactable by the electrical contact means. The electrical contacting may be automated, e.g. in a production line. This makes it particularly easy to heat up the heating element. Such a design is also suitable for series manufacturing of high unit quantities of battery arrangements. The heat generated and thus the temperature of the heating element can be adjusted via the impressing of the electric current. Depending on the plastic used, the temperature required to transfer the plastic to a molten state may vary. Accordingly, the concept according to exemplary embodiments of this disclosure can be universally applicable to a very wide variety of types of plastic.

According to a further embodiment of a battery arrangement, it can be provided that the heating element comprises a cable or a fiber tape. A cable may mean a rigid (inflexible), flexible or moldable electrically conductive conductor.

Such a “cable” may have an electrically conductive core surrounded by insulation. A “cable” may be branched and have a main wire, as well as branches (secondary wires). A “cable” may also be understood as a network or grid composed of one or more main wires and branch wires. A cable may be a metal wire that may be surrounded by insulation. A network or grid may be composed of one or more metal wires.

A fiber tape may be understood as meaning a tape comprising a plastic matrix and fibers embedded therein. The fibers may be unidirectionally oriented continuous fibers that together with the plastic matrix form a UD fiber tape. Such a fiber tape may increase the rigidity and stability of the component in question (e.g. the plastic container or the plastic cover). If a heating element in the form of a fiber tape is used, this can be arranged on the plastic container or the plastic cover by means of an injection molding process (e.g. by injection molding onto the plastic container or plastic cover) or additive manufacturing (e.g. by 3D printing). The plastic matrix may have a thermoplastic matrix in which the unidirectionally oriented fibers are embedded. The thermoplastic used here can preferably only pass into a molten state at a higher temperature than the plastic present in the plastic-container-side and plastic-cover-side joining section. This prevents the plastic matrix of the heating element from also melting when the heating element is heated up. It may also be desired, however, that the plastic matrix of the heating element softens during heating in order to form an integrally bonded connection with the plastic material of the respective joining sections, i.e. is inserted into the plastic-container-side and plastic-cover-side plastic material. Fibers may be carbon fibers or metal fibers, for example. Since these fibers are electrically conductive, UD tapes having such fibers are suitable for use as a heating element. By impressing electrical current into the UD tape (e.g. by applying an electrical voltage), the UD tape heats up and transfers the heat generated in the process to its surroundings. The UD tape may —at least in that case of the use of (reinforced) plastic material provided with metallic or ferromagnetic compounds or electrically conductive fibers (such as carbon fibers) in the plastic-container-side and plastic-cover-side joining section—be used for induction welding (for providing the joining connection). The UD tape may form an induction coil. Other heating elements (not in the form of UD tapes) may also form an induction coil.

In addition, an external induction coil may be used to form the joining connection. In this case, the provision of a heating element may be omitted. A heating element may additionally also be provided which can assist in forming the joining connection, or is provided only for releasing the joining connection.

In the case of induction welding, electromagnetic energy is emitted by the induction coil in the direction of the metallic or ferromagnetic compounds or electrically conductive fibers (such as carbon fibers) contained in the plastic material of the plastic container and/or plastic cover in the joining regions. There, the electromagnetic energy is at least partially absorbed, as a result of which thermal energy is generated and the surrounding plastic can soften or liquefy. Thus, as described above, a joining connection can be formed.

According to a further refinement of an example battery arrangement, it can be provided that the temperature control unit has a temperature control flat body which is arranged between the plastic container base and the battery unit, wherein the fluid channel is integrated in the temperature control flat body. In this case, the fluid channel is therefore formed directly in the temperature control flat body. The temperature control flat body may for example, be in the shape of a plate or disk in which the fluid channel (or a plurality of fluid channels, or an interconnected fluid channel system) is integrated. The temperature control flat body may be a flat metal body, such as a metal plate or metal disk. Any suitable basic geometrical shapes may be used to provide the temperature control flat body. During the production, it can be provided that the temperature control flat body is first of all inserted into the plastic container (e.g. is placed onto the plastic container base), followed by inserting the battery unit into the plastic container, which is placed onto the temperature control flat body. The temperature control flat body may have one or more cutouts or bores through which one or more electrical connectors are routed. Electrical connectors may also be routed around the temperature control flat body from the outside in order to electrically contact the battery unit. With the use of a temperature control flat body, in particular a temperature control flat body made of metal, extensive and efficient cooling of one or more battery unit(s) can be ensured.

According to a further refinement of an example battery arrangement, it can be provided that the temperature control unit has a temperature control flat body which is arranged between the plastic container base and the battery unit, and that the fluid channel is formed by a channel structure which provides the fluid channel and is formed in a surface of the plastic container base and is at least partially sealed by the temperature control flat body. In this case, the fluid channel is therefore delimited on the one hand by the channel structure formed in the plastic container base (e.g. a semi-open channel with a V- or U-shaped cross section) and by the temperature control flat body. The temperature control flat body may be formed flat, i.e. in a planar manner, facing the channel structure formed in the plastic container base, and, with its surface, delimit the channel structure to the outside.

Also, in the temperature control flat body, in its surface facing the plastic-container-base-side channel structure, a channel structure corresponding to the plastic-container-base-side channel structure may be formed, wherein both channel structures together form the fluid channel. In this case, the fluid channel is formed by in each case a channel substructure formed in the plastic container base and a channel substructure formed in the temperature control flat body. Between the channel structure formed in the plastic container base and the temperature control flat body, a seal may be arranged for further sealing of the fluid channel. Likewise, a seal may be arranged between said channel substructures. For example, the temperature control flat body may be in the shape of a plate or disk. The temperature control flat body may be a flat metal body, such as a metal plate or metal disk. Any suitable basic geometrical shapes may be used to provide the temperature control flat body. During the production, it can be provided that the temperature control flat body is first of all inserted into the plastic container (e.g. is placed onto the plastic container base), followed by inserting the battery unit into the plastic container, which is placed onto the temperature control flat body. The temperature control flat body may have one or more cutouts or bores through which one or more electrical connectors are routed. Electrical connectors may also be routed around the temperature control flat body from the outside in order to electrically contact the battery unit. With the use of a temperature control flat body, in particular a temperature control flat body made of metal, extensive and efficient cooling of one or more battery unit(s) can be ensured.

According to a further refinement of an example battery arrangement, it can be provided that the electrical line forms a framework structure which mechanically stabilizes the plastic container base and thus the plastic container. The electrical line may be designed, for example, in the form of a grid, in particular a leadframe. The framework structure, e.g. the leadframe, may be a plastic grid in which one or more electrical conductors are integrated. The plastic grid may also act as an insulator.

As already mentioned, the object on which exemplary embodiments of this disclosure are based can also achieved by a method for producing a battery arrangement.

The method can comprise:
a. forming a plastic container by injection molding, additive manufacturing or a forming process, wherein a plastic container formed in such a manner has a plastic container opening, a plastic container base, and an encircling plastic container side wall adjacent to the plastic container base, wherein the plastic container opening lies opposite the plastic container base, and wherein, during the injection molding, additive manufacturing or forming process, an electrical line is directly integrated in the plastic container base and an electrical connector connected to the electrical line is partially integrated in the plastic container base,
b. providing a plastic cover, for example by injection molding, additive manufacturing or a forming process,
c. arranging a temperature control unit in the plastic container, wherein the temperature control unit has a fluid channel through which a temperature control fluid can flow,
d. arranging a battery unit in the plastic container and connecting the battery unit to the electrical connector, wherein the temperature control unit and the battery unit are arranged in such a manner that the temperature control unit is arranged between the plastic container base and the battery unit,
e. covering the plastic container opening with the plastic cover,
f. fastening the plastic cover to the plastic container.

The method may also comprise: arranging a heating element on the plastic container or on the plastic cover before fastening the plastic cover to the plastic container. In this case, fastening of the plastic cover to the plastic container can take place by heating of the heating element in order to produce a joining connection between a plastic-container-side joining section and a plastic-cover-side joining section, wherein, in addition, for the production of the joining connection, the plastic cover is pressed against the plastic container and/or the plastic container is pressed against the plastic cover.

It can therefore be provided to merely press the plastic cover against a positionally fixed plastic container, or to merely press the plastic container against a positionally fixed plastic cover. Alternatively, both components (plastic cover and plastic container) may be pressed against each other. Pressure may be applied manually (e.g. by hand) or automatically (by machine).

A fixed joining connection is formed after the joined plastic have hardened or cooled down, i.e. have solidified. Curing may be externally, e.g. by external cooling.

The heating element may be arranged on the plastic container or on the plastic cover following the injection molding, the additive manufacturing or the forming process (i.e. as a result of cooling/curing of the injection-molded or the additively manufactured component or component manufactured by a forming process), but also before or during the injection molding, the additive manufacturing or the forming process. In the case of being arranged during the injection molding, the additive manufacturing or the forming process, the injection molding, the additive manufacturing or the forming process may be interrupted and the heating element positioned at a desired location. The injection molding, the additive manufacturing or the forming process may then be continued. It is also conceivable in principle to introduce or position the heating element in the casting mold of the injection molding die or to receive same for additive manufacturing during the injection molding or the additive manufacturing. When the heating element is arranged on the plastic container or the plastic cover before the injection molding, the heating element is preferably inserted into the cavity before the start of the injection molding and then insert-molded. The heating element can thus be integrated in the plastic container or the plastic cover. Arrangement and fastening of the heating element following the injection molding, the additive manufacturing or the forming process may be carried out, for example, by adhesive bonding, by mechanical fastening, or by application during an additional additive manufacturing step (e.g. 3D printing of a heating element in the form of a fiber tape).

Instead of the described fastening of the plastic cover to the plastic container via the formation of a joining connection, such a fastening may also be carried out in some other way, e.g. by forming an adhesive connection, screw connection, riveted connection, form-fitting connection, clamping connection or another suitable fastening variant.

The method features a. to f. mentioned here as well as possible further method features should not necessarily be understood as meaning a step sequence, but it is not excluded that the method may be carried out in such a step sequence.

As mentioned, the plastic container can be produced by injection molding, additive manufacturing, or a forming process. The plastic cover may also be manufactured by injection molding, additive manufacturing or a forming process. Manufacturing by means of an injection-molding process, additive manufacturing or by a forming process may also mean that parts of the plastic container and/or plastic cover are manufactured by means of an injection-molding process, additive manufacturing or by a forming process and these container parts or cover parts are then connected or fastened to one another.

During the injection molding, a material (in this case a plastic) is liquefied, e.g. melted, in an injection-molding machine and injected under pressure into a casting mold. Multi-component systems, for example mixtures of different plastic or composite plastic, may also be processed using the injection-molding process. The interior of the casting mold (which may also be referred to as a cavity) determines the shape and the surface structure of the injection-molded component (that is, e.g., the plastic container or the plastic cover). Fibers for fiber reinforcement may be added to the plastic used or to the mixture of plastic.

Additive manufacturing may be understood as meaning a process in which components (e.g. the plastic container or the plastic cover) are generated by successive (additive) application or deposition of material. In exemplary embodiments of the present disclosure, said material is a fluid (e.g. liquefied) plastic or mixture of plastic to which fibers may be added. The additive manufacturing may be carried out, for example, by a 3D printer. In this case, fluid material is provided layer by layer, said fluid material firstly being deposited onto a carrier surface or receptacle of a manufacturing device and then being deposited onto the already-applied (and optionally at least partially hardened or solidified) material. A thermoplastic is particularly suitable as a fluid matrix material. The material may undergo a chemical hardening (this is understood to mean, in particular, a polymerization which can be initiated thermally or in a radiation-based manner), but at the same time also a physical or thermal hardening. Functional elements such as the electrical line or the electrical connector may be introduced, e.g. inserted, into the matrix material at a suitable location as the manufacturing process proceeds. Subsequently, additional matrix material is added so that the functional element is embedded (integrated) in and surrounded by the matrix material. The functional element can be introduced into the matrix material in such a way that it is only partially surrounded by the matrix material, i.e. partially protrudes out of the matrix material or is arranged on a surface of the matrix material.

A forming process may be understood, for example, as meaning thermoforming or hot forming, with a thermoplastic being formed under the action of heat and with the aid of compressed air or a vacuum.

As mentioned, an electrical line is directly integrated in the plastic container base during the injection molding, the additive manufacturing or the forming process. Furthermore, an electrical connector connected to the electrical line is partially integrated in the plastic container base. The electrical line or the electrical connector is surrounded (optionally only partially) by (softened) plastic material which is liquefied during the injection molding, the additive manufacturing or the forming process. During the injection molding, the electrical line or the electrical connector is positioned at a desired location in the casting mold (cavity). Also, during the additive manufacturing, the electrical line or the electrical connector is positioned in a receptacle or on the carrier surface. The same applies self-explanatorily also to the case in which a plurality of electrical lines or electrical connectors are integrated in the plastic container base.

According to b., as mentioned, a plastic cover is provided, for example by injection molding, additive manufacturing or by a forming process. Other manufacturing processes are also conceivable. In this context, the term “provide” may mean that the plastic cover is provided for use (regardless of its manner of manufacturing).

According to c., a temperature control unit is arranged in the plastic container. The temperature control unit may be inserted by hand (i.e. manually) into the plastic container, but also automatically, e.g. robotically (e.g. by means of a robotic gripper). In this case, the temperature control unit is arranged in such a way that the electrical connector (or a plurality of electrical connectors) protrudes through the temperature control unit, so that an arrangement of a battery unit (cf. d) in the plastic container and connection of the battery unit to the electrical connector (or to a plurality of electrical connectors) is made possible in a simple manner, for example by plugging them on. The temperature control unit may have corresponding cutouts or bores through which an electrical connector (or the plurality of electrical connectors) can be routed. Between an electrical connector and a battery unit, a plug connection is preferably provided.

According to e., the plastic container opening is covered by the plastic cover. The plastic cover with an encircling cover edge is preferably placed/laid onto an (encircling, upper) edge of the plastic container side wall, which edge delimits the plastic container opening. This can be carried out manually or automatically (e.g. robotically).

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

For a better understanding of the present disclosure, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further in the figures, like reference numbers refer to like parts throughout the different figures.

FIG. 1 shows a schematic illustration of a battery arrangement according to an exemplary embodiment where the upper view from FIG. 1 is a side view and the lower view from FIG. 1 is a plan view.

FIG. 2 shows a plan view of an embodiment of a temperature control unit, as can be used in a battery arrangement according to FIG. 1.

FIGS. 3a-f show a schematic illustration of a method sequence of an exemplary method for producing a battery arrangement, wherein the battery arrangement is the battery arrangement from FIG. 1, and wherein FIGS. 3a-f each illustrate a side view in an upper view and a plan view in a lower view.

FIG. 4a shows a schematic illustration of a contour of an upper edge of a plastic container side wall, which is part of a plastic container as part of a battery arrangement, with joining sections being indicated.

FIG. 4b shows a schematic illustration of a contour of a edge of a plastic cover, which is part of a battery arrangement, with joining sections being indicated.

### DETAILED DESCRIPTION

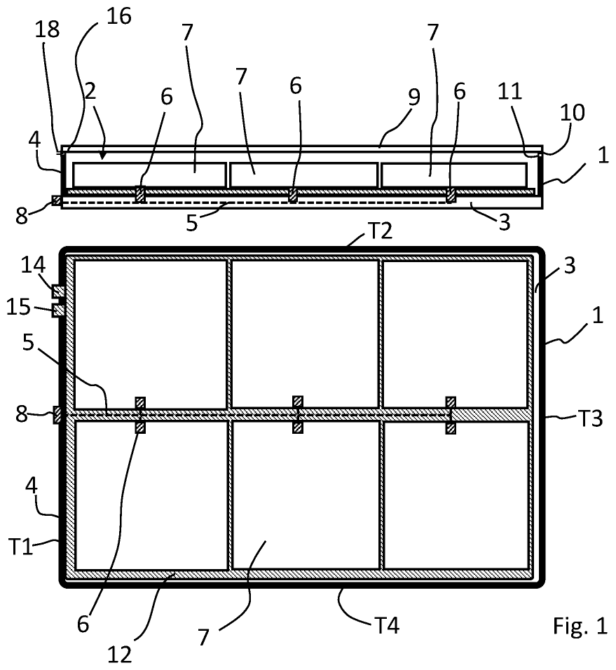

FIG. 1 illustrates an embodiment of a battery arrangement according to the present disclosure, wherein the upper view reproduces a side view and the lower view a plan view.

The battery arrangement includes a plastic container 1 with a plastic container opening 2. A plastic container base 3 is arranged opposite the plastic container opening 2. The plastic container base 3 forms a bottom of the plastic container 1.

The plastic container base 3 is adjoined by an encircling plastic container side wall 4 consisting of four partial walls T1, T2, T3, T4. The partial walls T1, T2, T3, T4 of the side wall 4 are arranged perpendicular to the plastic container base 3. Adjacent partial walls T1, T2, T3, T4 are also arranged perpendicular to one another. The partial walls T1 and T3 lie opposite each other as do the partial walls T2 and T4. The plastic container 1 forms a box made of plastic.

In the exemplary embodiment, an electrical line 5 is integrated in the plastic container base 3. The electrical line 5 can be incorporated directly into the plastic container base 3 during the manufacturing of the plastic container 1, for example during the injection molding or by way of additive manufacturing (e.g. 3D printing).

In the figures, the electrical line 5 is shown in the form of a dashed line. The electrical line 5 is electrically connected to electrical connectors 6. The electrical connectors 6 are—as shown in FIG. 1 in the side view of the battery arrangement—partially integrated in the plastic container base 3, or embedded therein, i.e. at in each case one end, the electrical connectors 6 are in contact with the electrical line, while an end opposite this end is electrically connected to a battery unit 7 arranged in the plastic container 1.

In the battery arrangement shown, six battery units 7 are arranged in the plastic container 1 and electrically connected via respective electrical connectors 6 to the electrical line 5. The electrical line 5 is electrically connected to an electrical contact 8 arranged on an outer side of the plastic container 1. For example, electrical consumers arranged outside the plastic container 1 can be electrically connected via the electrical contact 8. In short, electrical energy from the battery units 7 can be tapped off or supplied thereto (the latter, for example, when charging the battery units 7) via the electrical contact 8.

The upper view (side view) of the battery arrangement from FIG. 1 shows that the plastic container opening 2 is covered or closed by a plastic cover 9. The plastic cover 9 is connected to the plastic container 1 via a joining connection. For this purpose, one or more plastic-container-side joining sections are integrally bonded to one or more plastic-cover-side joining sections. The joining connection is preferably formed in the region of an encircling cover edge 10 and an upper edge 11 of the side wall 4.

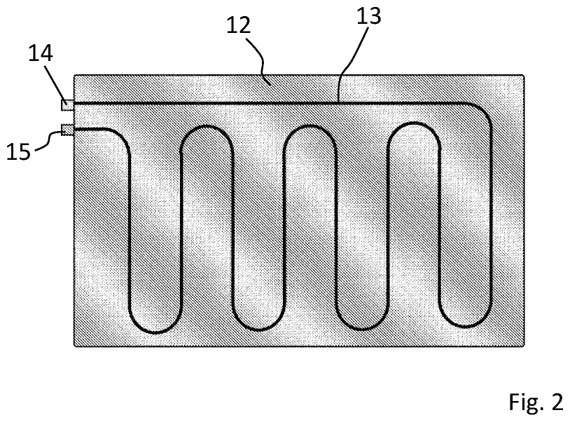

With reference now to FIG. 2 and continuing reference to FIG. 1, a temperature control unit 12 designed as a temperature control flat body (in particular as a plate) is arranged between the plastic container base 3 and the battery units 7. The electrical connectors 6 protrude through the temperature control unit 12 in order to electrically contact the battery units 7. The temperature control unit 12 has a fluid channel 13 through which a temperature control fluid can flow in order to control the temperature of, in particular to cool, the battery units 7. The temperature control fluid is preferably a coolant that may be liquid or gaseous.

The fluid channel 13 is directly integrated in the plate-like temperature control unit 12 and runs from a temperature control fluid inlet 14 to a temperature control fluid outlet 15, the fluid channel 13 extending in meandering or spiral form along the plate-shaped temperature control unit 12. The fluid channel 13 forms a closed fluid circuit, if the temperature control fluid flowing out of the fluid channel 13 via the temperature control fluid outlet 15 is subsequently supplied again to the temperature control fluid inlet 14. A heat exchanger or temperature control assembly (e.g. a cooling assembly) may be arranged between the temperature control fluid inlet 14 and temperature control fluid outlet 15.

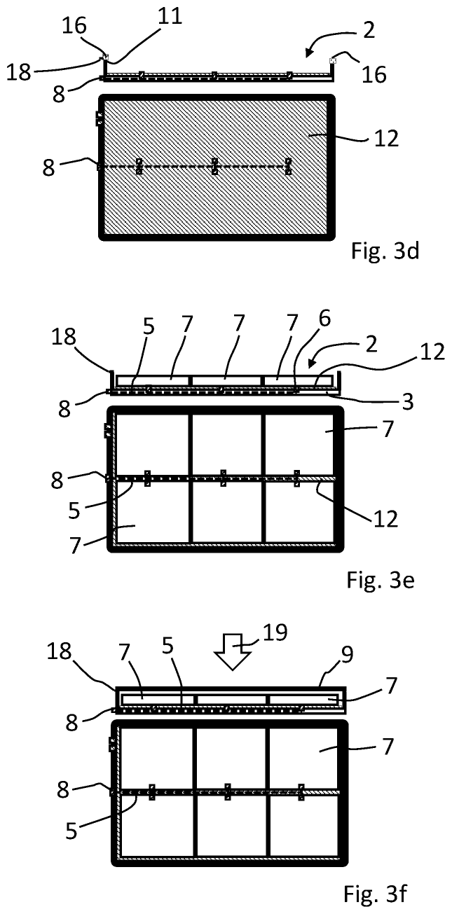

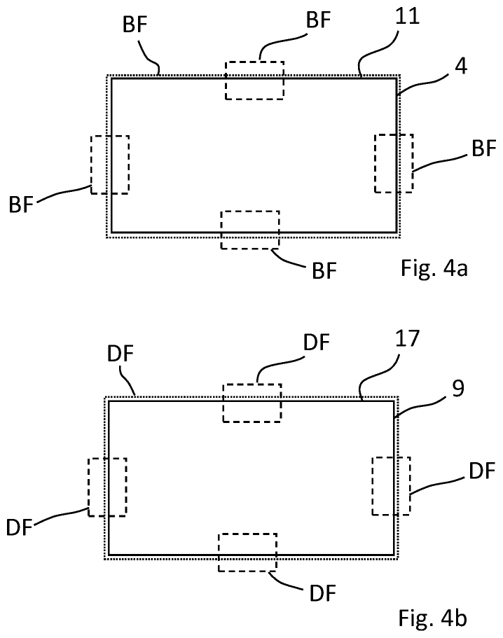

With reference now to FIGS. 4a and 4b, and continuing reference to FIGS. 1 and 2, a heating element 16 is arranged on the plastic container 1 or on the plastic cover 9 and, in the case of a plastic container opening 2 covered by the plastic cover 9, is designed for this purpose for producing a joining connection between a plastic-container-side joining section BF and a plastic-cover-side joining section DF, or for releasing an already existing joining connection, by heating of the heating element 16. The heating element 16 is formed conductively with respect to an electric current such that the heating element 16 can be heated when the electric current is impressed by an electrical contact means 18. The electrical contact means 18 protrudes outside the plastic container 1.

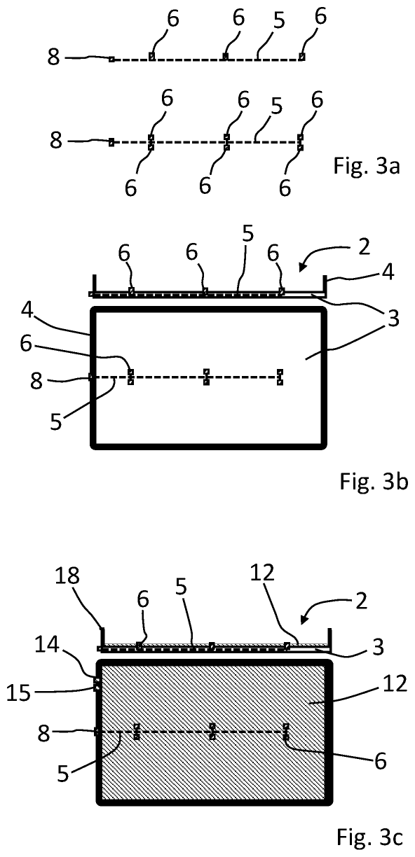

FIGS. 3a to 3f illustrate a method for producing a battery arrangement. Each of the illustrations according to FIGS. 3a to 3f shows a side view in an upper view and a plan view of the battery arrangement according to the respective manufacturing step in a lower view.

As shown in FIG. 3a, an electrical line 5 is first of all electrically connected to electrical connectors 6. This arrangement is positioned in an injection-molding die (namely in a cavity of same). An arrangement on a carrier surface or in a receptacle for a 3D printing process is also possible.

As shown in FIG. 3b, the electrical line 5 is surrounded (e.g. insert-molded) by plastic by means of an injection-molding process or additive manufacturing (such as 3D printing). The electrical connectors 6 are only partially surrounded by plastic material. In the method step shown in FIG. 3b, the plastic container 1 is formed simultaneously in the injection-molding process or by additive manufacturing. The electrical line 5 is integrated in the plastic container base 3. The injection-molded or additively manufactured plastic container 1 has said plastic container base 3 and an encircling plastic container side wall 4 adjacent to the plastic container base 3, the plastic container side wall 4 having four partial walls T1, T2, T3, T4. The plastic container base 3 lies opposite a plastic container opening 2.

Through the plastic container opening 2, a plate-like temperature control unit 12 can be arranged and placed in the plastic container 1, cf. FIG. 3c. The electrical connectors 6 protrude through the plate-like temperature control unit 12, for which purpose the temperature control unit 12 can have cutouts or bores.

As shown in FIG. 3d, the heating element 16 is then arranged on an edge 11 of the plastic container side wall 4. The heating element 16 preferably extends along the entire encircling edge 11. For example, the heating element 16 may also be printed onto the edge 11 (e.g. by means of 3D printing, if the heating element 16 is a fiber tape). The heating element 16 is connected to an electrical contact means 18.

As shown in FIG. 3e, in a next step, battery units 7 are arranged in the plastic container 1, the battery units 7 being electrically connected, for example via a plug connection, to electrical connectors 6 respectively assigned to them. As can be seen, the temperature control unit 12 is arranged between the plastic container base 3 and the battery units 7.

As shown in FIG. 3f, the plastic container opening 2 is then covered by the plastic cover 9. The plastic cover 9 is then fastened to the plastic container 1 by applying pressure (indicated by the arrow 19) and heating the heating element 16 in order to produce a joining connection between a plastic-container-side joining section BF and a plastic-cover-side joining section DF. The plastic-container-side joining section BF is formed here along the edge 11. The plastic-cover-side joining section DF is formed correspondingly along an edge 17 of the plastic cover 9.

FIG. 4a schematically shows the contour of an upper edge 11 of the side wall 4 of the plastic container 1, while FIG. 4b shows the contour of an edge 17 of the plastic cover 9. When covering the plastic container opening 2 with the plastic cover 9, the edges 11, 17 lie against each other, with the plastic cover 9 resting on the plastic container 1. In the example shown, the contours of the edges 11, 17 are rectangular. Provision may be made for a collar to be formed at one of the edges 11, 17 and for a groove receiving the collar to be formed at the other of the edges 11, 17. If the edges 11, 17 lie against each other, the collar can engage in said groove. In one example, four plastic-container-side joining sections BF (cf. the regions illustrated by dashed lines) are arranged at the edge 11 of the side wall 4 of the plastic container 1, while, in one example, four plastic-container-side joining sections DF (cf. also the regions illustrated by dashed lines) are arranged at the edge 17 of the plastic cover 9. The respective joining sections BF, DF are manufactured from a thermoplastic or a fiber-reinforced thermoplastic. Using the heating element 16, a joining connection is in each case formed between the joining sections BF, DF. The joining sections BF, DF may be distributed in a punctiform manner along the edges 11, 17, but may also be formed in an encircling manner, as illustrated by means of the dotted line for the joining sections BF and DF, and extend along the entire edges 11, 17.

It should be understood that, on the premise of technical feasibility, the technical features listed above for different embodiments can be combined with each other to form other embodiments within the scope of the present disclosure.

It should be understood that, on the premise of technical feasibility, the technical features listed above for different embodiments can be combined with each other to form other embodiments within the scope of the present disclosure.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery arrangement for a vehicle, comprising:
a plastic container, having a plastic container opening, a plastic container base, and an encircling plastic container side wall adjacent to the plastic container base, wherein the plastic container opening lies opposite the plastic container base;
an electrical line integrated in the plastic container base;
a battery unit arranged in the plastic container;
an electrical connector that is partially integrated in the plastic container base and that provides an electrical connection between the electrical line and the battery unit;
a plastic cover with which the plastic container opening can be covered; and
a temperature control unit arranged between the plastic container base and the battery unit, the temperature control unit having a fluid channel through which a temperature control fluid can flow in order to control a temperature of the battery unit.

2. The battery arrangement according to claim 1, further comprising a heating element that is arranged on the plastic container or on the plastic cover, the heating element configured to produce a joining connection between a plastic-container-side joining section and a plastic-cover-side joining section by heating of the heating element.

3. The battery arrangement according to claim 2, wherein the plastic container is manufactured from a thermoplastic or a fiber-reinforced thermoplastic at least in a region of the plastic-container-side joining section, wherein the plastic cover is manufactured from a thermoplastic or a fiber-reinforced thermoplastic at least in the region of the plastic-cover-side joining section.

4. The battery arrangement according to claim 2, wherein the plastic-container-side joining section and the plastic-cover-side joining section at least partially lie against each other, with the plastic container opening covered by the plastic cover, before the joining connection is formed or after the joining connection is released.

5. The battery arrangement according to claim 2, wherein the heating element is arranged on the plastic-container-side joining section or on the plastic-cover-side joining section.

6. The battery arrangement according to claim 2, wherein the heating element is formed conductively with respect to an electric current such that the heating element can be heated when the electric current is impressed by an electrical contact.

7. The battery arrangement according to claim 2, wherein the heating element comprises a cable or a fiber tape.

8. The battery arrangement according to claim 1, further comprising a heating element that is arranged on the plastic container or on the plastic cover, the heating element configured to release a joining connection between a plastic-container-side joining section and a plastic-cover-side joining section by heating of the heating element.

9. The battery arrangement according to claim 1, wherein the temperature control unit has a temperature control flat body which is arranged between the plastic container base and the battery unit, wherein the fluid channel is integrated in the temperature control flat body.

10. The battery arrangement according to claim 1, wherein the temperature control unit has a temperature control flat body which is arranged between the plastic container base and the battery unit, and in that the fluid channel is formed by a channel structure which provides the fluid channel and is formed in a surface of the plastic container base and is at least partially sealed by the temperature control flat body.

11. The battery arrangement according to claim 1, wherein the electrical line forms a framework structure which mechanically stabilizes the plastic container base and thus the plastic container.

12. A method for producing a battery arrangement for a vehicle, comprising:
forming a plastic container in such a manner that the plastic container has a plastic container opening, a plastic container base, and an encircling plastic container side wall adjacent to the plastic container base, the plastic container opening lies opposite the plastic container base,
during the forming, at least partially integrating an electrical line and an electrical connector in the plastic container base, the electrical connector connected to the electrical line;
providing a plastic cover;
arranging a temperature control unit in the plastic container, the temperature control unit having a fluid channel through which a temperature control fluid can flow;
arranging a battery unit in the plastic container and connecting the battery unit to the electrical connector, the temperature control unit and the battery unit arranged in such a manner that the temperature control unit is between the plastic container base and the battery unit;
covering the plastic container opening with the plastic cover; and
fastening the plastic cover to the plastic container.

13. The method of claim 12, further comprising: arranging a heating element on the plastic container or on the plastic cover before fastening the plastic cover to the plastic container.

14. The method of claim 13, wherein the plastic cover is fastened to the plastic container by heating of the heating element in order to produce a joining connection between a plastic-container-side joining section and a plastic-cover-side joining section, wherein, in addition, for production of the joining connection, the plastic cover is pressed against the plastic container and/or the plastic container is pressed against the plastic cover.

15. The method of claim 12, wherein the forming includes forming by injection molding.

16. The method of claim 12, wherein the forming includes forming by additive manufacturing.
